(19) United States
(12) Patent Application Publication
(10) Pub. No.: US 2007/0251500 A1
(43) Pub. Date: Nov. 1, 2007

(54) Fuel pressure controller

(75) Inventors: Takashi Kikutani, Ama-gun (JP); Hisashi Endo, Obu-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/783,005

(22) Filed: Apr. 5, 2007

(30) Foreign Application Priority Data
Apr. 27, 2006 (JP) 2006-122845

(51) Int. Cl. F02M 57/02; F02M 59/36

(52) U.S. Cl. 123/458; 123/446

(57) ABSTRACT

A fuel pump suctions fuel from a fuel tank and discharges the fuel. A discharge metering valve regulates an amount of the discharged fuel out of the suctioned fuel. The discharged amount is regulated by operating closing timing for closing the discharge metering valve through energization of the discharge metering valve. The fuel discharged by the fuel pump is pressure-fed to a common rail. A rotation angle interval between energizing operations of the discharge metering valve is lengthened when rotation speed of an output shaft of a diesel engine is high. Thus, a residual magnetic flux in the discharge metering valve is reduced. As a result, control of the fuel pressure can be suitably performed.

### CROSS REFERENCE TO RELATED APPLICATION

This application is based on and incorporates herein by reference Japanese Patent Application No. 2006-122845 filed on Apr. 27, 2006.

### BACKGROUND OF THE INVENTION

1. Field of the Invention

The present invention relates to a fuel pressure controller applied to a fuel supply system having a fuel pump that has an electromagnetic discharge metering valve for regulating a fuel amount discharged to an outside out of suctioned fuel and that is driven by a driving force of an internal combustion engine and a pressure accumulation chamber that accumulates the fuel pressure-fed by the fuel pump at a high-pressure state, the fuel pressure controller controlling fuel pressure in the pressure accumulation chamber by operating the discharge metering valve.

2. Description of Related Art

JP-A-H4-272471 describes a fuel supply system of this kind structured such that fuel is suctioned when a plunger of a fuel pump moves to a bottom dead center and such that a discharge metering valve is closed through electromagnetic drive to break communication between a fuel supply side and a plunger side when the plunger moves to a top dead center. This fuel supply system discharges the fuel remaining on the plunger side from the fuel pump to an outside when the metering valve is closed. JP-A-H4-272471 describes a fuel pressure controller that calculates a basic value of valve closing timing of the metering valve based on a target value of the fuel pressure in a pressure accumulation chamber (common rail) common to respective cylinders and a command value of an injection amount of an injector and that performs feedback correction of the basic value based on a difference between a sensed value of the fuel pressure and the target value of the fuel pressure. Thus, the fuel amount can be suitably regulated.

A force applied to the metering valve by the fuel increases if rotation speed increases. In such a case, there is a possibility that the metering valve closes (i.e., causes spontaneous closure) and the fuel is discharged from the fuel pump unintentionally although the closing operation of the metering valve is not performed. Therefore, the above-described fuel pressure controller operates the metering valve to a closed state constantly under such the situation. Thus, the fuel pressure controller stops the suctioning of the fuel when the plunger moves to the bottom dead center to prohibit the discharge of the fuel from the fuel pump.

Inventors of the present invention found that the minimum value of the rotation speed causing the spontaneous closure of the metering valve is lower than a value at which the force applied by the fuel is balanced out with a force of a member for opening the metering valve. This is attributed to the fact that the closing of the metering valve is facilitated by a residual magnetic flux remaining after the closing operation of the metering valve. Therefore, stoppage of the fuel pressure-feeding operation of the fuel pump is required at rotation speed lower than the maximum rotation speed, which is decided by mechanical properties and is not supposed to cause the closure of the metering valve.

A circuit for removing the residual magnetic flux of the metering valve may be provided. However, this can cause an increase in the size of a drive circuit driving the metering valve or an increase in the number of components.

### SUMMARY OF THE INVENTION

It is an object of the present invention to provide a fuel pressure controller capable of suitably controlling fuel pressure by operating an electromagnetic discharge metering valve that regulates a fuel amount discharged to an outside out of suctioned fuel.

According to an aspect of the present invention, a fuel pressure controller has a reduction device that reduces the number of operations of a discharge metering valve to lengthen an interval between pressure-feeding operations with respect to the shortest cycle, in which a fuel pump can discharge fuel, when rotation speed of an internal combustion engine is equal to or higher than predetermined speed.

In this structure, the shortest cycle, in which the fuel pump can discharge the fuel, coincides with the operation cycle of the discharge metering valve during normal processing. The time interval between the operations of the discharge metering valve shortens as the rotation speed increases. Therefore, there is a possibility that the residual magnetic flux does not reduce sufficiently during the time interval. Moreover, the force applied to the discharge metering valve by the fuel increases and the spontaneous closure of the discharge metering valve is induced more as the rotation speed increases. The above-described structure reduces the number of the operations of the discharge metering valve to lengthen the interval between the pressure-feeding operations when the rotation speed is equal to or higher than the predetermined speed. Accordingly, the residual magnetic flux of the discharge metering valve can be suitably reduced. As a result, the rotation speed causing the spontaneous closure of the discharge metering valve can be increased, so the control of the fuel pressure can be suitably performed.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a diagram showing an engine system according to a first embodiment of the present invention;

FIG. 2 is a sectional view showing a fuel pump according to the first embodiment;

FIG. 3 is a flowchart showing processing steps of fuel pressure control according to the first embodiment;

FIG. 4 is a time chart showing a mode of the fuel pressure control according to the first embodiment;

FIG. 5 is a time chart showing a mode of normal processing and a mode of reduction processing according to the first embodiment;

FIG. 6 is a time chart showing a mode of suction prohibition processing according to the first embodiment;

FIG. 7 is a flowchart showing processing steps of operation of the fuel pump according to the first embodiment;

FIG. 8 is a flowchart showing processing steps of the reduction processing according to the first embodiment;

FIG. 9 is a diagram showing an improved mode of spontaneous closure rotation speed of a discharge metering valve according to the first embodiment;

FIGS. 10A and 10B are diagrams showing a switching mode of various types of processing according to a second embodiment of the present invention; and

FIG. 11 is a flowchart showing processing steps of suction restriction according to a third embodiment of the present invention.

### DETAILED DESCRIPTION OF EXAMPLE EMBODIMENTS

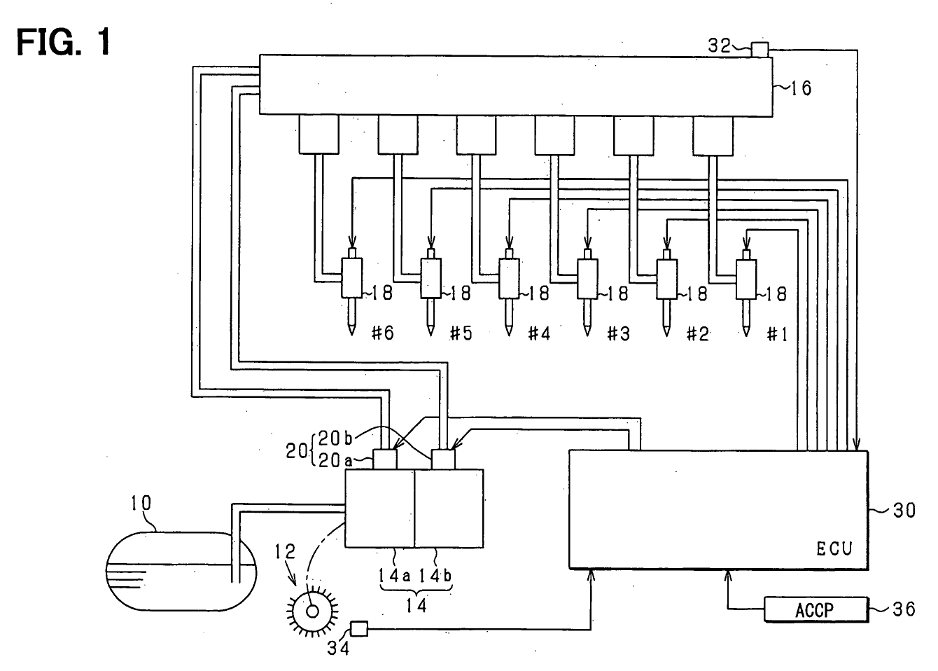

Referring to FIG. 1, an engine system according to a first embodiment of the present invention is illustrated. An engine-driven fuel pump 14 draws fuel stored in a fuel tank 10. The fuel pump 14 is applied with a force by an output shaft 12 of a diesel engine. The fuel pump 14 includes a pair of fuel pumps 14a, 14b and a discharge metering valve 20 consisting of a pair of normally-open discharge metering valves 20a, 20b. The discharge metering valve 20 regulates a discharged fuel amount out of the fuel drawn from the fuel tank 10. The fuel discharged from the fuel pump 14 is pressure-fed to a common rail 16, which supplies the fuel to injectors 18 of respective cylinders (six cylinders in the present embodiment).

An electronic control unit 30 (ECU) receives sensing values of various sensors sensing operation states of the engine such as a fuel pressure sensor 32 sensing the fuel pressure in the common rail 16 and a rotation angle sensor 34 sensing a rotation angle of the output shaft 12 and a sensing value of an accelerator sensor 36 sensing an operation amount ACCP of an accelerator pedal. The ECU 30 performs output control of the engine by operating actuators of the engine such as the discharge metering valve 20 and the injectors 18 based on the sensing values of the sensors. At that time, the ECU 30 controls the fuel pressure in the common rail 16 to a target value of the fuel pressure (target fuel pressure) to suitably perform the output control of the engine.

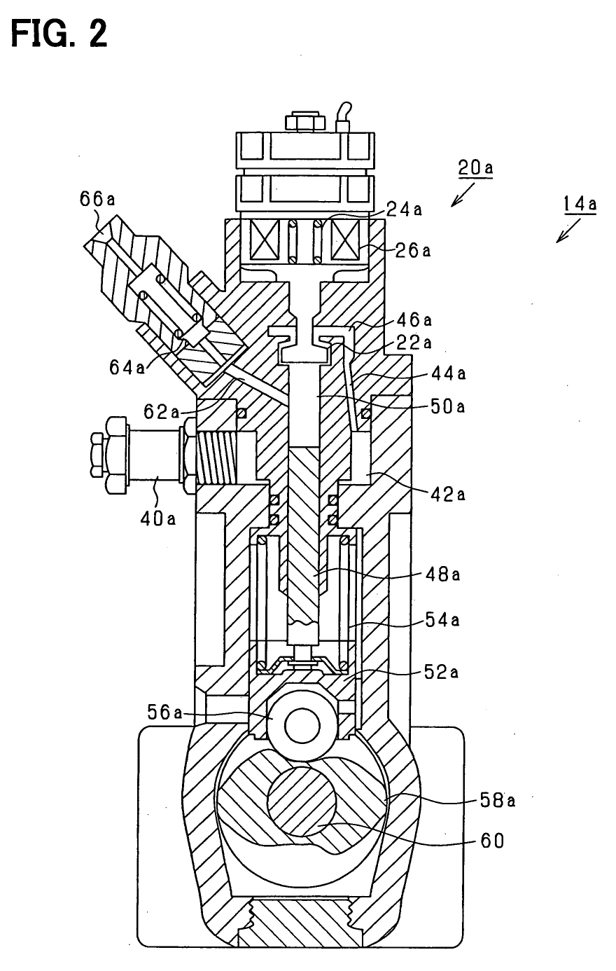

FIG. 2 shows a structure of the fuel pump 14. Though FIG. 2 shows only a part of the fuel pump 14 (fuel pump 14a) corresponding to the discharge metering valve 20a, the fuel pump 14 also has the same members corresponding to the discharge metering valve 20b as the members shown in FIG. 2. As shown in FIG. 2, the fuel pump 14a is formed with a fuel introduction passage 40a connected with the fuel tank 10. The fuel introduction passage 40a communicates with a low-pressure chamber 42a. The low-pressure chamber 42a can communicate with a pressurization chamber 50a through a supply passage 44a and a gallery 46a. The pressurization chamber 50a is defined by an inner wall of the fuel pump 14a and a plunger 48a.

An end of the plunger 48a opposite from the pressurization chamber 50a is linked with a valve seat 52a. The valve seat 52a is pushed by a plunger spring 54a in a direction opposite to the pressurization chamber 50a, i.e., toward a cam roller 56a. The cam roller 56a is located to contact a cam 58a. The cam 58a is linked with a camshaft 60, which is linked with the output shaft 12 and which rotates once while the output shaft 12 rotates twice. If the camshaft 60 rotates in accordance with the rotation of the output shaft 12, the plunger 48a reciprocates between a top dead center and a bottom dead center. Thus, the pressurization chamber 50a is expanded and contracted. The pressurization chamber 50a can communicate with a discharge hole 66a through a discharge passage 62a and a check valve 64a.

Communication between the pressurization chamber 50a and the gallery 46a is provided and broken by a valve member 22a of the discharge metering valve 20a. The discharge metering valve 20a has a valve spring 24a and an electromagnetic solenoid 26a. The valve spring 24a biases the valve member 22a toward the pressurization chamber 50a, i.e., in a valve opening direction. The electromagnetic solenoid 26a attracts the valve member 22a in a direction opposite to a restoring force of the valve spring 24a, i.e., in a valve closing direction. FIG. 2 shows a state in which a magnetic flux of the electromagnetic solenoid 26a is zero and the valve member 22a is in a valve-opened state due to the force of the valve spring 24a.

With this structure, the fuel in the low-pressure chamber 42a is suctioned into the pressurization chamber 50a through the supply passage 44a and the gallery 46a when the plunger 48a moves from the top dead center to the bottom dead center in accordance with the rotation of the output shaft 12 and the volume of the pressurization chamber 50a increases. The fuel in the pressurization chamber 50a is pressurized if the communication between the pressurization chamber 50a and the low-pressure chamber 42a is broken by closing the valve member 22a when the plunger 48a moves from the bottom dead center to the top dead center and the volume of the pressurization chamber 50a reduces. If the force caused by the fuel pressure in the pressurization chamber 50a exceeds the force for bringing the check valve 64a to a valve-closed state, the check valve 64a opens and the fuel in the pressurization chamber 50a is discharged from the discharge hole 66a to an outside.

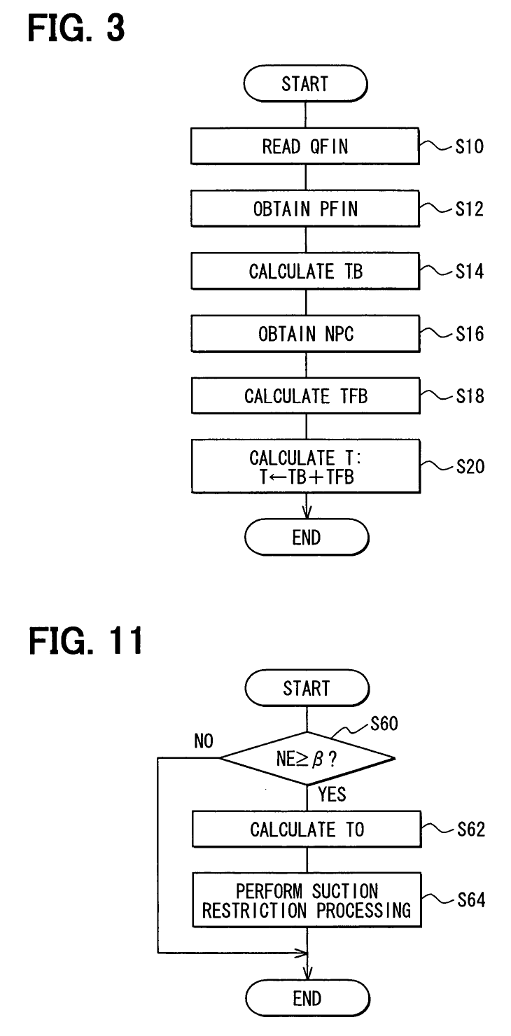

FIG. 3 shows processing steps regarding the control of the fuel pressure in the common rail 16 performed by the ECU 30. The ECU 30 repeatedly performs the processing shown in FIG. 3, for example, in a predetermined cycle. In a series of the processing, first, Step S10 reads a command value of an injection amount of the injector 18 (command injection amount QFIN). The command injection amount QFIN is calculated based on the operation amount ACCP of the accelerator pedal and the rotation speed NE of the output shaft 12 by separate logic (not shown). Following Step S12 obtains the target fuel pressure PFIN of the common rail 16. The target fuel pressure PFIN is calculated based on the rotation speed NE of the output shaft 12 and the command injection amount QFIN by separate logic (not shown).

Following Step S14 calculates a basic value TB of valve closing timing of the discharge metering valve 20 based on the target fuel pressure PFIN and the command injection amount QFIN. The basic value TB of the valve closing timing is advanced more as the command injection amount QFIN increases. This corresponds to that the required discharge amount of the fuel pump 14 increases as the command injection amount QFIN increases. The basic value TB is advanced more as the fuel pressure increases. It is because, for example, an amount of the fuel that leaks from the common rail 16 into the fuel tank 10 through the injector 18 without being injected by the injector 18 increases as the fuel pressure increases. No leak passage is shown in FIG. 1 for the sake of simplicity. Step S14 may calculate the basic value TB by using a map deciding a relationship among the target fuel pressure PFIN, the command injection amount QFIN and the basic value TB.

Following Step S16 reads the sensing value NPC of the fuel pressure sensor 32. Step S18 calculates a feedback correction value TFB based on the sensed value NPC of the fuel pressure and the target fuel pressure PFIN. For example, the feedback correction value TFB may be calculated in accordance with a proportional term, a differential term and an integral term based on a difference between the sensed value NPC of the fuel pressure and the target fuel pressure PFIN. Following Step S20 calculates final valve closing timing T by adding the feedback correction value TFB to the basic value TB of the valve closing timing. The desired fuel can be discharged from the fuel pump 14 by performing the valve closing operation of the discharge metering valve 20 at the valve closing timing T.

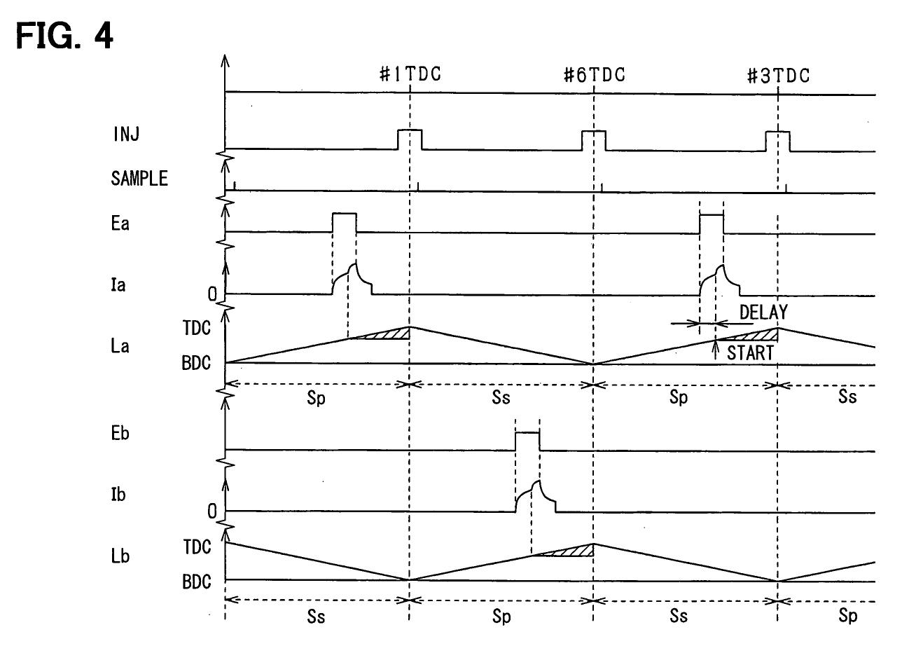

FIG. 4 shows a mode of the above-described fuel pressure control. In FIG. 4, INJ represents injection timing of the injector 18, SAMPLE is sampling timing of the sensed value NPC of the fuel pressure used in the processing shown in FIG. 3, Ea is an energization command period of the discharge metering valve 20a, Ia is drive current of the discharge metering valve 20a, and La is a transition of a lift amount of the plunger 48a. Eb represents an energization command period of the discharge metering valve 20b, Ib is a drive current of the discharge metering valve 20b and Lb is a transition of a lift amount of the plunger 48b. #1TDC, #3TDC and #6TDC represent top dead centers of the first, third and sixth cylinders respectively. Ss represents a suction stroke of each one of the fuel pumps 14a, 14b, and Sp is a pressure-feeding stroke of each one of the fuel pumps 14a, 14b. TDC and BDC respectively represent the top dead center and the bottom dead center of each one of the plungers 48a, 48b. Each of shaded areas in FIG. 4 shows a discharge stroke of each one of the fuel pumps 14a, 14b.

As shown in FIG. 4, the system according to the present embodiment is a synchronous system that relates the top dead center of each one of the plungers 48a, 48b to the top dead center of each cylinder of the engine on one-to-one basis and that relates the fuel injection to the fuel pressure-feeding on one-to-one basis. The fuel is suctioned into the pressurization chamber 50a (50b) if the plunger 48a (48b) moves from the top dead center to the bottom dead center (during suction stroke Ss). The fuel is discharged from the fuel pump 14 by closing the discharge metering valve 20a (20b) when the plunger 48a (48b) moves from the bottom dead center to the top dead center (during pressure-feeding stroke Sp).

If the drive current is caused to flow through the electromagnetic solenoid 26a (26b) of the discharge metering valve 20a (20b), there occurs a point (pressure-feeding start point: START shown in FIG. 4), at which the increase amount of the current rapidly enlarges and the discharge metering valve 20a (20b) closes. Accordingly, a certain delay (DELAY shown in FIG. 4) is caused between the energization command start applied to the discharge metering valve 20a (20b) and the pressure-feeding start point. Therefore, adjustment for compensating for the delay should be preferably applied to the processing of calculating the basic value TB in the processing shown in FIG. 3.

The end of the energization of the electromagnetic solenoid 26a (26b) is advanced from the timing at which the plunger 48a (48b) reaches the top dead center. It is because the fuel applies a force to the valve member 22a (22b) to close during the pressure-feeding stroke and the discharge metering valve 20a (20b) maintains the closed state during the pressure-feeding stroke once the discharge metering valve 20a (20b) closes.

The fuel pressure in the common rail 16 can be controlled by pressure-feeding the fuel from the fuel pump 14 to the common rail 16 in the manner described above.

When the plunger 48a (48b) moves from the bottom dead center to the top dead center, the fuel in the pressurization chamber 50a (50b) flows out to the low-pressure chamber 42a (42b) before the valve member 22a ( 22b) of the discharge metering valve 20a (20b) closes. At that time, a restrictor effect between the pressurization chamber 50a (50b) and the gallery 46a (46b) causes a differential pressure between the pressurization chamber 50a (50b) and the gallery 46a (46b). The differential pressure applies a force to the valve member 22a (22b) in a direction of the movement of the plunger 48a (48b). The force tends to increase as the reciprocation speed of the plunger 48a (48b) increases. That is, the force increases as the rotation speed of the output shaft 12 increases.

If the force exceeds the restoring force of the valve spring 24a (24b) pushing the valve member 22a (22b) in the valve opening direction, the valve member 22a (22b) spontaneously change to the closed state (i.e., causes spontaneous closure) although the energization operation of the electromagnetic solenoid 26a (26b) is not performed. If the spontaneous closure of the valve member 22a (22b) occurs, the fuel amount discharged from the fuel pump 14 exceeds an intended amount. As a result, there is a possibility that the fuel pressure in the common rail 16 excessively increases over the target fuel pressure PFIN.

The spontaneous closure of the valve member 22a (22b) occurs when the resultant force generated by the fuel in the pressurization chamber 50a (50b) and the residual magnetic flux in the magnetic solenoid 26a (26b) exceeds the force of the valve spring 24a (24b). Normally, the time interval between the operations of the discharge metering valve 20a (20b) shortens as the rotation speed increases. Accordingly, the residual magnetic flux that is caused by the previous operation of the discharge metering valve 20a (20b) and that remains even at the present operation of the discharge metering valve 20a (20b) increases as the rotation speed increases.

Therefore, it is certainly expected that the rotation speed causing the spontaneous closure can be increased by reducing the residual magnetic flux in the electromagnetic solenoid 26a (26b) remaining before the start of the energization in the pressure-feeding stroke. The residual magnetic flux attenuates with time. Therefore, the system according to the present embodiment performs reduction processing (thinning processing) for reducing the number of the operations of the discharge metering valves 20a, 20b to lengthen the interval between the pressure-feeding operations with respect to the shortest cycle, in which the fuel pump 14 can discharge the fuel, when the rotation speed of the output shaft 12 is equal to or higher than predetermined speed. Thus, increase of the rotation speed causing the spontaneous closure is aimed.

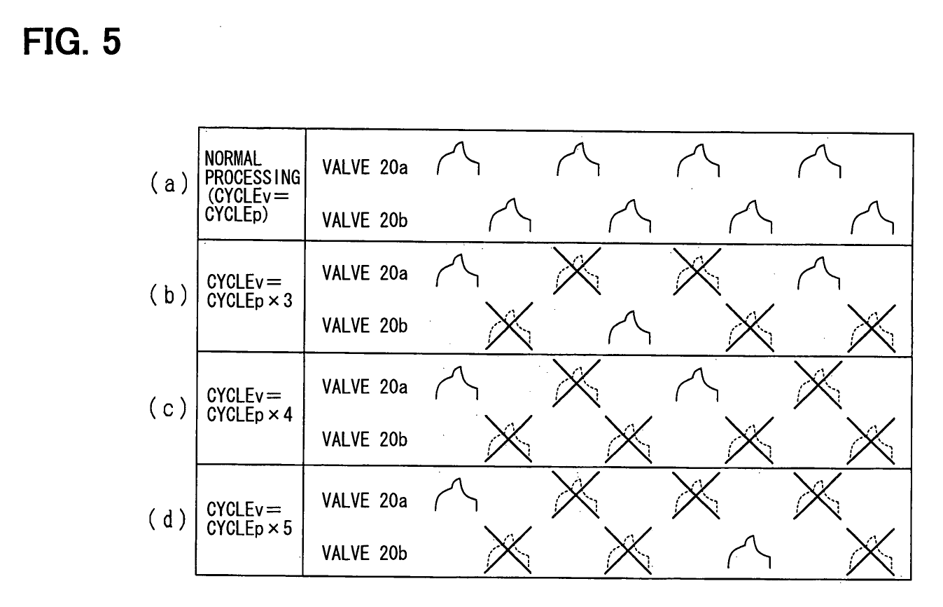

Part (a) of FIG. 5 shows an operation mode of the discharge metering valves 20a, 20b during a normal period. Part (b) to Part (d) of FIG. 5 show operation modes of the discharge metering valves 20a, 20b during the reduction processing. Part (b) of FIG. 5 shows an example in which the operation cycle of the discharge metering valves 20a, 20b is set three times as long as that of the normal period. Part (c) of FIG. 5 shows an example in which the operation cycle of the discharge metering valves 20a, 20b is set four times as long as that of the normal period. Part (d) of FIG. 5 shows an example in which the operation cycle of the discharge metering valves 20a, 20b is set five times as long as that of the normal period.

As shown in FIG. 5, the rotation angle interval between the time when the drive current is caused to flow through the discharge metering valves 20a, 20b and the time when the drive current is caused to flow through the metering valves 20a, 20b next time lengthens as the operation time number of the discharge metering valves 20a, 20b is decreased. Thus, the residual magnetic flux due to the previous drive current can be sufficiently reduced before the present operation.

There exists certain rotation speed (mechanical spontaneous closure limit speed), at which the force caused by the fuel in the pressurization chamber 50a (50b) exceeds the restoring force of the valve spring 24a (24b) although the electromagnetic solenoid 26a (26b) is not energized at all. The rotation speed causing the spontaneous closure can be increased by performing the above-described reduction processing. However, in this case, a margin of the rotation speed before the mechanical spontaneous closure limit speed is reached is reduced. Accordingly, there is a possibility that the rotation speed exceeds the mechanical spontaneous closure limit speed if the rotation speed unintentionally increases excessively during the reduction processing. In this case, there is a possibility that the discharge metering valve 20a (20b) closes even if the energization of the electromagnetic solenoid 26a (26b) is stopped and that the fuel is pressure-fed to the common rail 16 excessively.

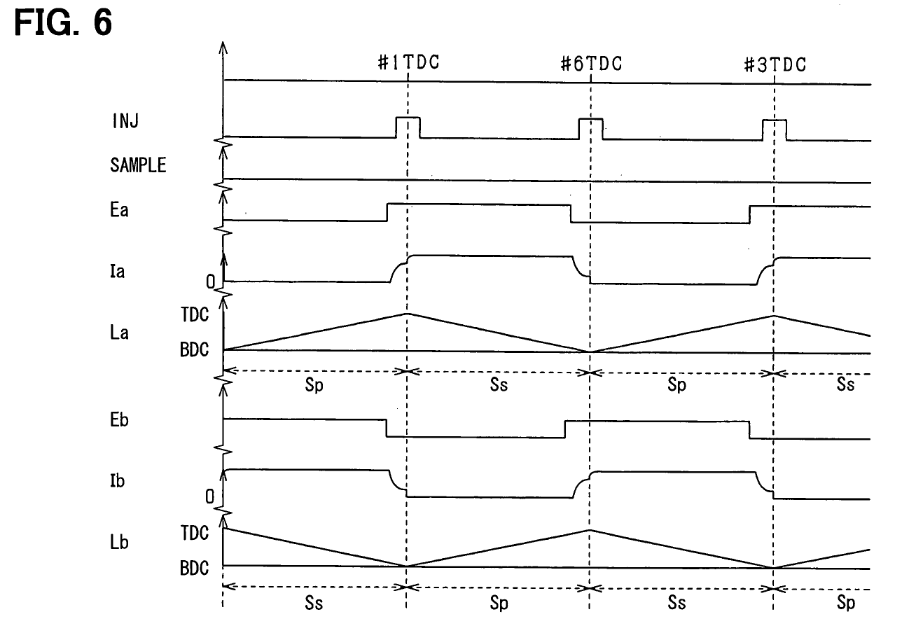

Therefore, the system according to the present embodiment energizes the electromagnetic solenoid 26a (26b) to close the discharge metering valve 20a (20b) during the suction stroke in which the plunger 48a (48b) moves from the top dead center toward the bottom dead center if the rotation speed NE of the output shaft 12 approaches to the mechanical spontaneous closure limit speed. Thus, the communication between the pressurization chamber 50a (50b) side and the low-pressure chamber 42a (42b) side is broken. Thus, there is little or no fuel in the pressurization chamber 50a (50b) when the plunger 48a (48b) moves from the bottom dead center toward the top dead center, so the fuel discharge from the fuel pump 14 can be prohibited. FIG. 6 shows a processing mode related to the prohibition of the fuel suction during the suction stroke.

As shown in FIG. 6, the energization command Ea (Eb) of the discharge metering valve 20a (20b) is outputted when the plunger 48a (48b) is positioned on a slightly advanced side of the top dead center (TDC), so the discharge metering valve 20a (20b) can be surely closed after the plunger 48a (48b) reaches the top dead center. The energization command Ea (Eb) is removed when the plunger 48a (48b) is positioned on a slightly advanced side of the bottom dead center (BDC). The removing timing of the energization command Ea (Eb) is set at timing capable of maintaining the discharge metering valve 20a (20b) at the closed state until the plunger 48a (48b) reaches the bottom dead center. As shown in FIG. 6, the removing timing of the energization command Ea (Eb) is set at as advanced a side as possible such that the energization of the electromagnetic solenoid 26a (26b) is surely stopped after the timing, after which the closure of the discharge metering valve 20a (20b) is unnecessary. Thus, the energization period of the electromagnetic solenoid 26a (26b) can be shortened. Accordingly, heat release from the electromagnetic solenoids 26a, 26b or from the ECU 30 energizing the electromagnetic solenoids 26a, 26b is reduced.

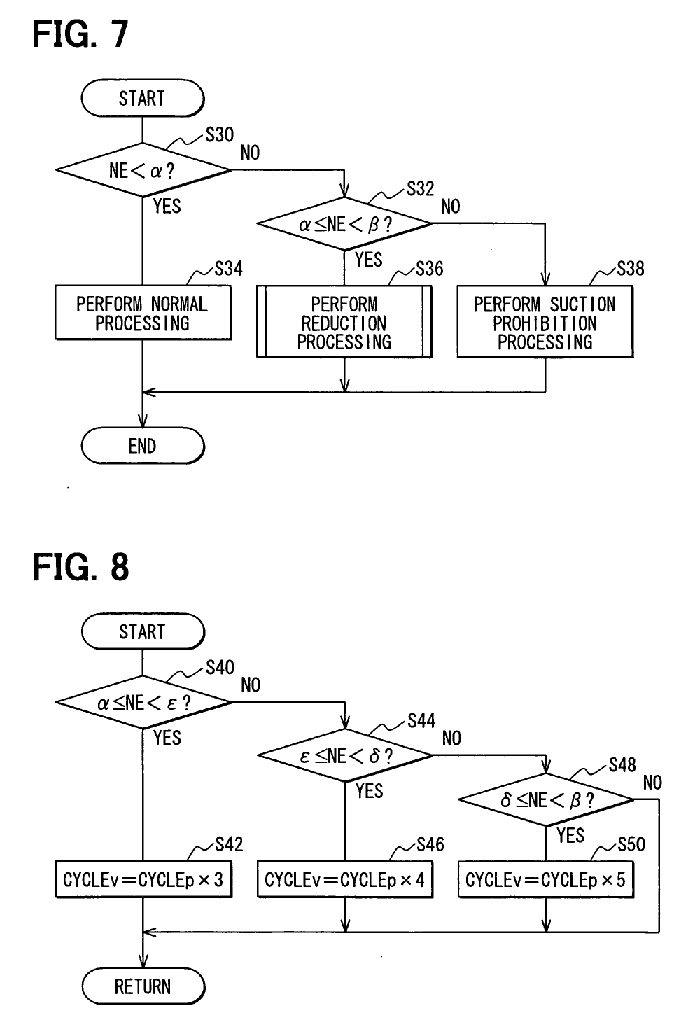

FIG. 7 shows processing steps of the operation of the fuel pump 14 corresponding to the rotation speed of the output shaft 12. The ECU 30 repeatedly performs the processing shown in FIG. 7, for example, in a predetermined cycle. In a series of the processing, if the rotation speed NE is less than predetermined speed a (Step S30: YES), normal processing for conforming the cycle (CYCLEv) of the processing shown in FIG. 3 to the shortest cycle (plunger cycle CYCLEp), in which the fuel pump 14 can discharge the fuel, is performed (Step S34). The shortest cycle CYCLEp is a period of the rotation angle of the output shaft 12 from the time when either one of the plungers 48a, 48b reaches the top dead center to the time when the other one of the plungers 48a, 48b reaches the top dead center.

If the rotation speed NE of the output shaft 12 is equal to or higher than the speed a and is less than speed β (Step S32: YES), the reduction processing is performed (Step S36). The speed β is set at speed equal to or lower than the lowest rotation speed causing the spontaneous closure even when the reduction processing is performed. The reduction processing can be performed by setting the cycle CYCLEv of the processing shown in FIG. 3 at a cycle longer than the plunger cycle CYCLEp (i.e., CYCLEv>CYCLEp). If the rotation speed NE of the output shaft 12 is equal to or higher than the speed β (Step S36: NO), suction prohibition processing for prohibiting the suctioning of the fuel in the suction stroke is performed (Step S38).

FIG. 8 shows the processing of Step S36 in detail. In a series of the processing, the cycle CYCLEv of the processing shown in FIG. 3 (control cycle) is set three times as long as the plunger cycle CYCLEp (i.e., CYCLEv=CYCLEp×3) (Step S42) if the rotation speed NE of the output shaft 12 is equal to or higher than the speed a and is lower than speed ε (Step S40: YES). Thus, the discharge metering valves 20a, 20b are operated in the mode shown in Part (b) of FIG. 5. If the rotation speed NE of the output shaft 12 is equal to or higher than the speed β and is lower than speed 6 (Step S44: YES), the cycle CYCLEv of the processing shown in FIG. 3 is set four times as long as the plunger cycle CYCLEp (i.e., CYCLEv=CYCLEp×4) (Step S46). Thus, the discharge metering valves 20a, 20b are operated in the mode shown in Part (c) of FIG. 5. If the rotation speed NE of the output shaft 12 is equal to or higher than the speed δ and is lower than the speed β (Step S48: YES), the cycle CYCLEv of the processing shown in FIG. 3 is set five times as long as the plunger cycle CYCLEp (i.e., CYCLEv=CYCLEp×5) (Step S50). Thus, the discharge metering valves 20a, 20b are operated in the mode shown in Part (d) of FIG. 5.

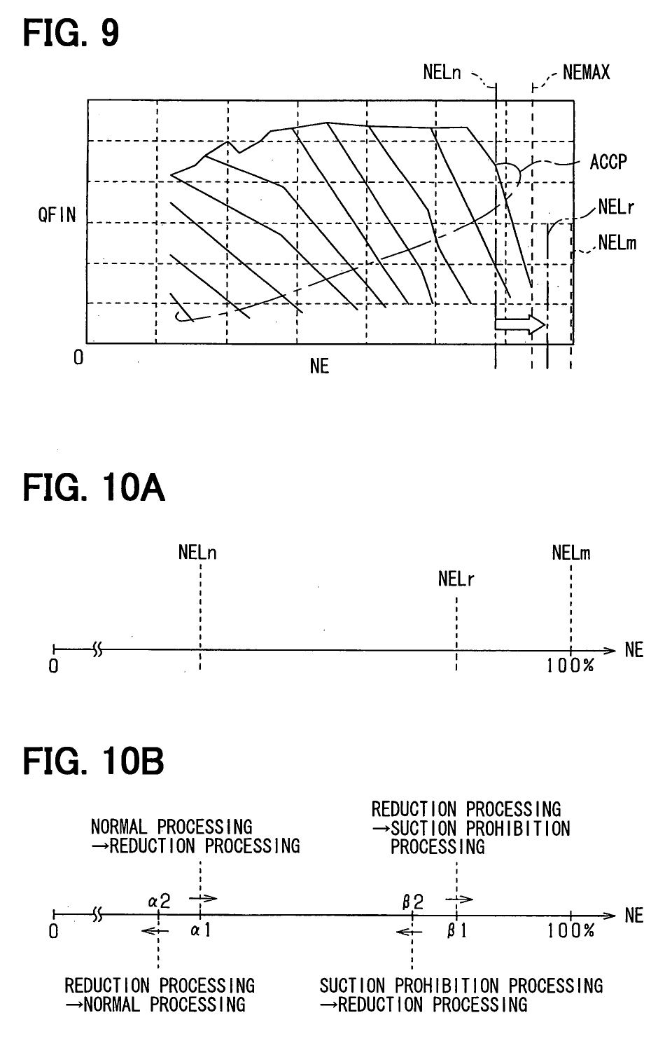

FIG. 9 shows a situation of the rotation speed causing the spontaneous closure of the discharge metering valves 20a, 20b improved by the above-described processing. FIG. 9 shows the improved situation over a governor pattern, which decides the command injection amount QFIN used in the processing shown in FIG. 3 based on the rotation speed NE of the output shaft 12 and the operation amount ACCP of the accelerator pedal. As shown in FIG. 9, in the system according to the present embodiment, the spontaneous closure of the discharge metering valves 20a, 20b occurs at rotation speed NE (NELn) lower than the maximum rotation speed NEMAX of the governor pattern during the normal processing. NELn in FIG. 9 represents the lowest rotation speed causing the spontaneous closure during the normal processing (i.e., normal processing spontaneous closure limit speed NELn). By performing the reduction processing, the lowest rotation speed causing the spontaneous closure can be increased over the maximum rotation speed NEMAX. NELr in FIG. 9 represents the lowest rotation speed causing the spontaneous closure during the reduction processing (i.e., reduction processing spontaneous closure limit speed NELr). NELm in FIG. 9 represents the mechanical spontaneous closure limit speed. Thus, the fuel pressure-feeding operation of the fuel pump 14 can be appropriately performed to compensate the consumption of the fuel in the common rail 16 accompanying the fuel injection through the injectors 18. By setting the speed P used in the processing shown in FIG. 7 at the maximum rotation speed NEMAX or between the maximum rotation speed NEMAX and the mechanical spontaneous closure limit speed NELm, the suction prohibition processing can be performed when there is no need to compensate the consumption of the fuel in the common rail 16 caused by the fuel injection.

The present embodiment exerts following effects.

(1) The reduction processing for reducing the number of the operations of the discharge metering valves 20a, 20b is performed to lengthen the interval between the pressure-feeding operations with respect to the shortest cycle, in which the fuel pump 14 can discharge the fuel, if the rotation speed of the engine is equal to or higher than predetermined speed α. Thus, the rotation speed causing the spontaneous closure of the discharge metering valves 20a, 20b can be increased. Accordingly, the control of the fuel pressure can be performed more appropriately.

(2) The reduction processing is performed by lengthening the operation cycle of the discharge metering valves 20a, 20b. Thus, the pressure-feeding of the fuel into the common rail 16 can be performed cyclically, stabilizing the fuel pressure.

(3) The calculation cycle of the feedback correction value is also lengthened when the operation cycle is lengthened. Thus, the calculation load for calculating the feedback correction value can be reduced. Moreover, excessive increase of the absolute value of the integral term due to the reduction processing can be averted.

(4) The degree of lengthening the time interval between the pressure-feeding operations is increased as the rotation speed of the engine increases. Thus, the increase of the residual magnetic flux at the present operation of the discharge metering valves 20a, 20b due to the previous operation can be suitably averted while minimizing the lengthening of the interval between the pressure-feeding operations.

(5) The suctioning of the fuel during the suction stroke through the operation of the discharge metering valves 20a, 20b is prohibited when the rotation speed of the output shaft 12 is equal to or higher than the speed β. Thus, the spontaneous closure of the discharge metering valves 20a, 20b caused by the suctioned fuel can be surely averted. Moreover, by energizing the discharge metering valves 20a, 20b only during the suction stroke, the heat generation in the discharge metering valves 20a, 20b or the ECU 30 operating the discharge metering valves 20a, 20b can be suitably inhibited compared to the case where the discharge metering valves 20a, 20b are constantly energized.

(6) When the plunger 48a (48b) moves from the bottom dead center to the top dead center due to the driving force of the engine, the discharge metering valve 20a (20b) moves due to the electromagnetic drive in the direction of the movement of the plunger 48a (48b). Thus, the communication between the fuel supply side and the plunger 48a (48b) side is broken and the fuel is discharged to the outside. In such the structure, there is a possibility that the fuel applies the force to the discharge metering valve 20a (20b) to induce the spontaneous closure of the discharge metering valve 20a (20b) when the plunger 48a (48b) moves to the top dead center. Accordingly, the above-described effects can be exerted suitably.

Next, a system according to a second embodiment of the present invention will be explained. FIGS. 10A and 10B show a switching mode among the normal processing, the reduction processing and the suction prohibiting processing according to the present embodiment. As shown in FIGS. 10A and 10B, in the present embodiment, a condition, under which the rotation speed NE of the output shaft 12 coincides with rotation speed α1, is used as a lengthening condition for switching from the normal processing to the reduction processing in accordance with the increase of the rotation speed NE of the output shaft 12. A condition, under which the rotation speed NE of the output shaft 12 coincides with rotation speed α2 lower than the rotation speed α1, is employed as a shortening condition for switching from the reduction processing to the normal processing in accordance with the decrease in the rotation speed NE of the output shaft 12. The rotation speed al is set at rotation speed equal to or lower than the lowest rotation speed (normal processing spontaneous closure limit speed NELn) causing the spontaneous closure during the normal processing. With such the setting, hysteresis can be set when the interval between the pressure-feeding operations is changed. Accordingly, frequent repetition of the changing of the interval between the pressure-feeding operations can be averted.

Moreover, in the present embodiment, a condition, under which the rotation speed NE of the output shaft 12 coincides with rotation speed β1, is used as a condition for switching from the reduction processing to the suction prohibition processing in accordance with the increase of the rotation speed NE of the output shaft 12. A condition, under which the rotation speed NE of the output shaft 12 coincides with rotation speed 132 lower than the rotation speed β1, is used as a condition for switching from the suction prohibition processing to the reduction processing in accordance with the decrease in the rotation speed NE of the output shaft 12. The rotation speed β1 is set at rotation speed equal to or lower than the lowest rotation speed (reduction processing spontaneous closure limit speed NELr) causing the spontaneous closure during the reduction processing. With such the setting, hysteresis can be set when the processing is changed. Accordingly, frequent repetition of the changing of the processing can be averted.

The present embodiment can exert following effects in addition to the effects (1) to (6) of the first embodiment.

(7) The lengthening condition and the shortening condition are set differently from each other. Thus, the hysteresis can be set when the interval between the pressure-feeding operations is changed. As a result, frequent repetition of the changing of the interval between the pressure-feeding operations can be averted.

(8) The condition for switching from the reduction processing to the suction prohibition procession and the condition for switching from the suction prohibition processing to the reduction processing are set differently from each other. Accordingly, the hysteresis can be set when the processing is changed between the reduction processing and the suction prohibition processing. As a result, frequent repetition of the changing of the processing can be averted.

Next, a system according to a third embodiment of the present invention will be explained. The system according to the present embodiment performs processing for discharging the fuel from the fuel pump 14 also at rotation speed higher than the rotation speed causing the spontaneous closure during the reduction processing. FIG. 11 shows steps of the processing according to the present embodiment. The ECU 30 repeatedly performs the processing shown in FIG. 11, for example, in a predetermined cycle. In a series of the processing, first, Step S60 determines whether the rotation speed NE of the output shaft 12 is equal to or higher than the speed β. The speed β is et at a value for determining the timing for restricting the suctioning of the fuel into the pressurization chambers 50a, 50b of the fuel pump 14. The speed β is set equal to or lower than the lowest value of the rotation speed causing the spontaneous closure during the reduction processing.

If Step S60 is YES, Step S62 calculates the valve closure removing timing TO in the suction stroke based on the target fuel pressure PFIN and the sensed value NPC of the fuel pressure. The fuel in the low-pressure chambers 42a, 42b is suctioned into the pressurization chambers 50a, 50b after the valve closure is removed in the suction stroke. Accordingly, the fuel causes the spontaneous closure of the discharge metering valves 20a, 20b and the fuel can be discharged from the fuel pump 14. Therefore, by restricting the fuel suctioned into the pressurization chambers 50a, 50b to or under the required pressure-feeding amount required to conform the sensed value NPC of the fuel pressure to the target fuel pressure PFIN, the pressure-feeding operation can be continued while averting the excessive pressure-feeding of the fuel into the common rail 16.

After Step S62 calculates the valve closure removing timing TO, Step S64 performs suction restriction processing of the fuel pump 14. That is, the energization command is outputted to the discharge metering valve 20a (20b) at the timing slightly advanced from the top dead center of the plunger 48a (48b). Thus, the discharge metering valve 20a (20b) is closed after the top dead center, and the energization is ended at the valve closure removing timing TO.

The processing shown in FIG. 11 is effective processing for a system that performs the fuel injection at rotation speed higher than the lowest value of the rotation speed causing the spontaneous closure during the reduction processing.

The present embodiment can exert following effects in addition to the effects (1) to (4) and (6) of the first embodiment.

(9) The fuel suction amount during the suction stroke is restricted to or under the required pressure-feeding amount required to conform the sensed value of the fuel pressure to the target fuel pressure when the rotation speed of the output shaft 12 is higher than the speed β. Thus, the pressure-feeding of the excessive fuel to the common rail 16 can be averted.

The above-described embodiments may be modified as follows.

In the third embodiment, the valve closure removing timing is not limited to the timing decided based on the sensed value of the fuel pressure and the target fuel pressure. For example, the timing may be decided further in consideration of the rotation speed, for example.

The lengthening mode of the operation cycle of the discharge metering valve 20 in the reduction processing is not limited to the mode shown in FIG. 5. For example, the operation cycle may be lengthened to be twice as long as the operation cycle of the normal processing period.

The condition for lengthening the interval between the pressure-feeding operations and the condition for shortening the interval between the pressure-feeding operations at the time when the processing is switched at Step S42, S46 or S50 may be set differently from each other. Thus, the frequent switching of the processing at Step S42, S46, or S50 can be averted.

The effects (1) to (3) of the first embodiment can be exerted even if the processing for increasing the lengthening degree of the rotation angle interval between the pressure-feeding operations as the rotation speed increases is not performed in the reduction processing.

The fuel pump 14 may not include the pair of discharge metering valves 20a, 20b. Alternatively, the fuel pump 14 may have a single discharge metering valve commonly used by the plungers 48a, 48b, for example. The number of the plunger(s) may be one, three or more.

The fuel injection system of the engine is not limited to the synchronous system but may be an asynchronous system. The internal combustion engine is not limited to the diesel engine but may be a direct injection gasoline engine, for example.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel pressure controller applied to a fuel supply system having a fuel pump, which is driven by a driving force of an internal combustion engine to discharge and to pressure-feed fuel to a pressure accumulation chamber accumulating the pressure-fed fuel at a high-pressure state and which has an electromagnetic discharge metering valve for regulating a fuel amount discharged to an outside by the fuel pump out of fuel suctioned by the fuel pump, the fuel pump being capable of performing the fuel discharge in a certain shortest cycle, the fuel pressure controller comprising:
a control device that controls the fuel pressure in the pressure accumulation chamber by operating the discharge metering valve; and
a reduction device that reduces the number of operations of the discharge metering valve to lengthen an interval between the pressure-feeding operations with respect to the shortest cycle when rotation speed of the engine is equal to or higher than predetermined speed.

2. The fuel pressure controller as in claim 1, wherein
the reduction device lengthens an operation cycle of the discharge metering valve.

3. The fuel pressure controller as in claim 2, wherein
the control device includes a calculation device that calculates a feedback correction value of the operation of the discharge metering valve for performing feedback control of conforming a sensed value of the fuel pressure in the pressure accumulation chamber to a target value, and
the reduction device lengthens a calculation cycle of the feedback correction value when the reduction device lengthens the operation cycle of the discharge metering valve.

4. The fuel pressure controller as in claim 1, wherein
the reduction device increases a lengthening degree of the interval between the pressure-feeding operations as the rotation speed of the engine increases.

5. The fuel pressure controller as in claim 1, wherein
the reduction device lengthens the interval between the pressure-feeding operations under a lengthening condition when the rotation speed of the engine increases, and
the reduction device shortens the interval between the pressure-feeding operations under a shortening condition, which is different from the lengthening condition, when the rotation speed of the engine decreases.

6. The fuel pressure controller as in claim 1, further comprising:
a restriction device that restricts a suctioned amount of the fuel suctioned by the fuel pump during a fuel suction stroke of the fuel pump through the operation of the discharge metering valve during the suction stroke if the rotation speed of the engine exceeds upper limit speed higher than the predetermined speed.

7. The fuel pressure controller as in claim 6, wherein
the restriction device prohibits the suctioning of the fuel during the suction stroke if the rotation speed exceeds the upper limit speed.

8. The fuel pressure controller as in claim 6, wherein
the operation performed by the reduction device is switched to the operation performed by the restriction device under a certain condition different from a condition for switching from the operation performed by the restriction device to the operation performed by the reduction device.

9. The fuel pressure controller as in claim 1, wherein
the fuel pump has a plunger driven by the driving force of the engine to reciprocate between a top dead center and a bottom dead center, and
the fuel pump is structured such that, when the plunger moves from the bottom dead center to the top dead center because of the driving force of the engine, communication between a fuel supply side and a plunger side of the fuel pump is broken by displacement of the discharge metering valve, which is caused by electromagnetic drive, in the direction of the movement of the plunger and the fuel pump discharges the fuel to the outside.

10. A pressure control method of controlling fuel pressure in a pressure accumulation chamber accumulating fuel pressure-fed by a fuel pump, which is driven by a driving force of an internal combustion engine to discharge and to pressure-feed the fuel and which has an electromagnetic discharge metering valve for regulating a fuel amount discharged by the fuel pump out of fuel suctioned by the fuel pump, the fuel pump being capable of performing the fuel discharge in a certain shortest cycle, the pressure control method comprising the steps of:
controlling the fuel pressure in the pressure accumulation chamber by operating the discharge metering valve; and
reducing the number of operations of the discharge metering valve to lengthen an interval between the pressure-feeding operations with respect to the shortest cycle when rotation speed of the engine is equal to or higher than predetermined speed.
